(19) United States
(12) Patent Application Publication
(10) Pub. No.: US 2006/0267933 A1
(43) Pub. Date: Nov. 30, 2006

(54) Eliminating mechanical spring with magnetic forces

(76) Inventors: Li Chong Tai, Penang (MY); Chiang Sun Cheah, Butterworth (MY); Hun Kwang Lee, Penang (MY)

Correspondence Address: AGILENT TECHNOLOGIES INC., INTELLECTUAL PROPERTY ADMINISTRATION, M/S DU404, P.O. BOX 7599, LOVELAND, CO, 80537-0599, US

(21) Appl. No.: 11/136,883

(22) Filed: May 25, 2005

(51) Int. Cl. G09G 5/08

(52) U.S. Cl. 345/157

(57) ABSTRACT

Magnetic force is used to re-center a puck in a pointing device or similar transducer-based device. A user can apply finger pressure to move the puck laterally away from the central position. The puck has a first magnet system, and the base of the device has a second magnet system. The magnetic repulsion or other magnetic interaction returns the puck to a central position when the user removes the finger pressure.

### DESCRIPTION OF THE RELATED ART

Electromechanical transducer-based mechanisms can be found in a wide array of products, ranging from accelerometer systems to user input devices or controls for computers, games and machines. One such class of user input device is that which includes the computer mouse, joystick and other such pointing devices that are used to input directional or positional information. In computers, personal digital assistants, and similar equipment, a person commonly uses such a pointing device to position a cursor on a screen.

A problem associated with pointing devices relates to re-centering the device. In the case of a mouse, a user can only conveniently slide the mouse within a relatively small area on the user's desk or other work surface. If the user slides the mouse a distance that brings it to the boundary of this area, the user generally lifts the mouse and sets it down again more centrally within the area in preparation for using it again in this manner. To address this problem, joysticks and joystick-like pointing devices, such as the IBM TrackPoint™ used in laptop computers, have biasing mechanisms that re-center or return them to a neutral position when the user releases his or her grasp. Driver logic associated with such a pointing device causes the cursor position to change only while the user applies a force to the device; when the device re-centers, the cursor position does not change. Thus, a user can cause a cursor to move a distance on the screen that is much greater than the corresponding distance the user moves the pointing device.

In puck-based pointing devices, a laterally moveable puck is held by springs within a mounting that defines a field of motion. The springs maintain the puck centered within the field of motion when no external force is applied to the puck. A user can apply finger pressure to the puck in a generally lateral direction to slide the puck against the spring bias. When the user releases the pressure, the springs return the puck to the central or neutral position. The driver logic associated with the puck causes the cursor position to change only while the user applies a force; when the puck re-centers, the cursor position does not change. The driver logic generates directional information in response to signals received from capacitive sensors that sense the relative position between the puck and its mounting.

Although the above-described puck-based pointing device is easy to use and provides many advantages over prior pointing devices, springs are inherently subject to wear, accumulation of dirt, and associated reliability problems. It would be desirable to provide a mechanism for puck-based pointing devices or similar transducer-based devices that is more reliable than a spring-based mechanism. The present invention addresses these problems and deficiencies and others in the manner described below.

### SUMMARY OF THE INVENTION

The present invention relates to using magnetic force to center a puck within a transducer-based apparatus that generates signals in response to movement of the puck away from the centered position. The apparatus can be, for example, a pointing device for inputting directional information into a computer or other electronic device.

In an exemplary embodiment, the apparatus comprises a puck coupled to a first magnet system and a base coupled to a second magnet system. Each magnet system can comprise one or more permanent magnets, electromagnets, etc., or combinations thereof. The magnets can be of any suitable shape, size and arrangement. In the exemplary embodiment, the second magnet system comprises an annular magnet, and the puck and its first magnet system are disposed within the annular magnet. When the puck is centered, the first and second magnet systems interact (e.g., generate mutually repulsive forces) such that there is zero resultant lateral force exerted upon the puck. As a result, the puck stays centered. When a user moves the puck laterally away from the centered position, the magnetic interaction exerts a resultant force upon the puck that directs it back toward the center. In the exemplary embodiment, a suitable transducer system responds to movement of the puck in the manner of a conventional pointing device by generating signals representative of the direction of movement.

Using magnetic force instead of springs to center a puck in a pointing device not only improves reliability but also provides a smoother feel to the user, thereby enhancing the user's ability to smoothly and precisely navigate the cursor on the screen.

### BRIEF DESCRIPTION OF THE DRAWINGS

FIG. 1 is a top view of a pointing device in accordance with an exemplary embodiment of the present invention.

FIG. 2 is a cross-sectional view taken on line 2-2 of FIG. 1.

FIG. 3 is similar to FIG. 1 and shows a user moving the puck.

FIG. 4 is a cross-sectional view taken on line 4-4 of FIG. 1.

FIG. 5 is a generalized cross-sectional view similar to FIG. 1, illustrating the magnet polarization in the exemplary embodiment of FIGS. 1-4.

FIG. 6 is a generalized cross-sectional view similar to FIG. 5, illustrating the magnet polarization in another exemplary embodiment of the invention.

FIG. 7 is a generalized cross-sectional view similar to FIGS. 5 and 6, illustrating the magnet polarization in still another exemplary embodiment of the invention.

FIG. 8 is schematic block diagram of a transducer circuit for sensing puck movement.

### DETAILED DESCRIPTION OF PREFERRED EMBODIMENTS

In the following description, like reference numerals indicate like components to enhance the understanding of the invention through the description of the drawings. Also, although specific features, configurations, arrangements and steps are discussed below, it should be understood that such specificity is for illustrative purposes only. A person skilled in the relevant art will recognize that other features, configurations, arrangements and steps are useful without departing from the spirit and scope of the invention.

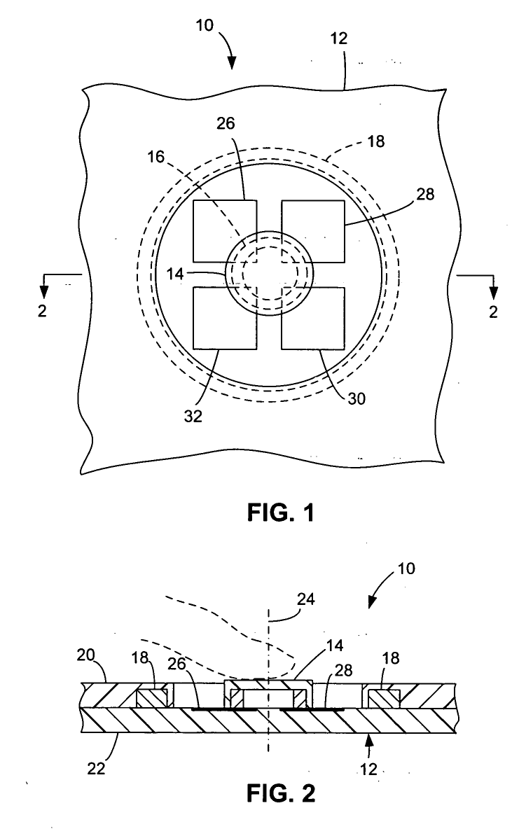

As illustrated in FIG. 1, a pointing device 10 in accordance with an exemplary embodiment of the invention includes a base 12, a puck 14, a first magnet system 16, and a second magnet system 18. Base 12 can be part of the case or other sub-assembly of a host device, such as a laptop computer, personal digital assistant (PDA), cellular telephone, or hybrid thereof, or it can be a separate element. In the exemplary embodiment, base 12 has a lower portion 20 and an upper portion 22, but in other embodiments it can comprise fewer elements or more elements and have any other suitable structure. First magnet system 16 comprises an annular magnet mounted in puck 14, and second magnet system 18 comprises an annular magnet mounted in base 12. Although in the exemplary embodiment of the invention, first and second magnet systems 16 and 18 each comprises a single annular permanent magnet, in other embodiments each can comprise one or more magnets of any suitable shape and type arranged in any suitable manner. One or more of the magnets can be permanent magnets as in the exemplary embodiment, or one or more can be electromagnets, as indicated in generalized form in FIG. 6. Still other magnet system combinations and variations will occur to persons skilled in the art to which the invention relates in view of the teachings herein. Similarly, although puck 14 and first and second magnet systems 16 and 18 are shown recessed within an area of base 12 in the exemplary embodiment, with the magnets enclosed or covered by portions of puck 14 and base 12 (as indicated by dashed line in FIG. 1), in other embodiments the puck and the magnet systems can be disposed in or on the base, enclosed or exposed in whole or part, in any other suitable manner. In this context, the terms “in” and “on” as used herein are intended to be synonymous.

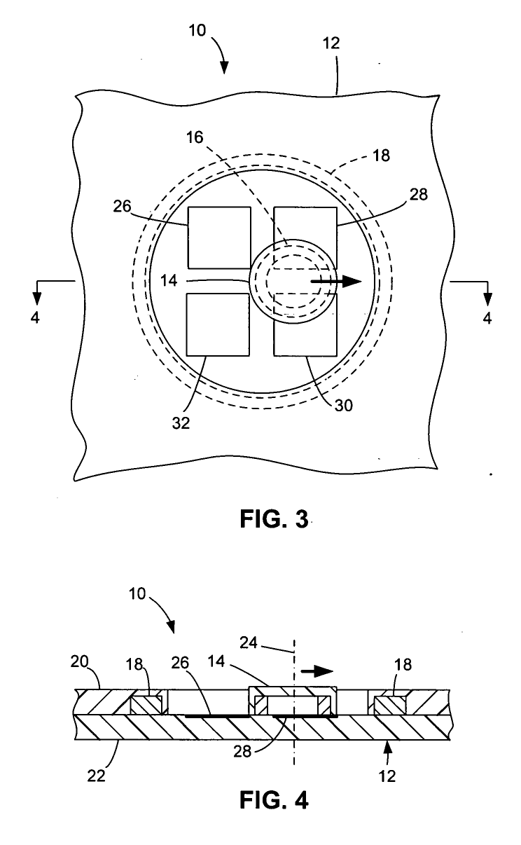

A user can move puck 14 (typically using his or her finger, as indicated in dashed line in FIG. 2) by applying a lateral force, i.e., a force in any direction substantially perpendicular to an axis 24 that is normal to a planar region in which puck 14 is movable. In the illustrated embodiment of the invention, the planar region is defined by a planar surface of base 12 on which puck 14 slides. (Indeed, although not shown for purposes of clarity, to minimize the sliding friction in such embodiments, one or both of the surfaces of puck 14 and base 12 in contact with each other can include TEFLON or other low-friction material.) Nevertheless, in other embodiments, any other means for facilitating movement of the puck within a planar region can be used. The force that the user applies in the lateral direction slides puck 14 in that direction, as indicated by the arrows in FIGS. 3-4. In this manner, a user can move puck 14 anywhere within the circular area of base 12 enclosed by the annular magnet of second magnet system 18.

It should be noted that FIGS. 1-4 are not to scale, and the user may need only a relatively small area in which to move puck 14; the distance a user moves puck 14 can be, for example, on the same order as that in which a user moves a conventional joystick, IBM TrackPoint™, or similar compact pointing device. Also, although puck 14 is disc-shaped or puck-shaped in the exemplary embodiment and laterally suspended within the circular area solely by magnetic force, in other embodiments the puck can have any suitable shape and structure, can be a part of some other assembly or mechanism, and can move in other dimensions and be used in other manners in addition to what is described herein. The term “puck” is therefore intended to include within its scope of meaning all such structures.

Pointing device 10 further includes a transducer system having electrode pads 26, 28, 30 and 32, which are electrically insulated from one another and from puck 14. Although illustrated for purposes of clarity as squares embedded or patterned in an upper surface of portion 22 of base 12, in other embodiments they can have any other suitable structure, shape and arrangement. For example, they can be patterned on the reverse surface of portion 22.

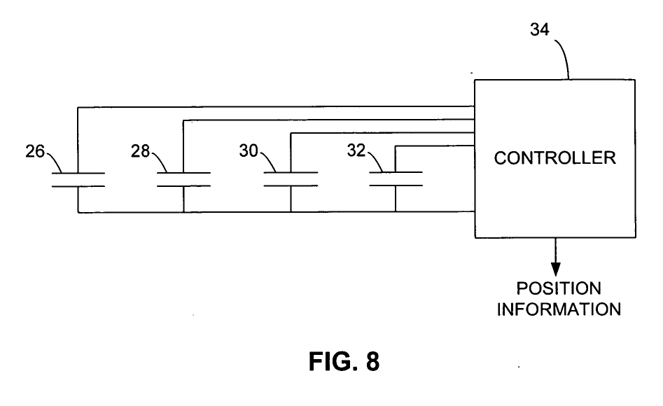

Four capacitances are defined by the amount that puck 14 overlaps each of electrode pads 26, 28, 30 and 32. These capacitances change as puck 14 moves over electrode pads 26, 28, 30 and 32. As illustrated in FIG. 8, an electronic controller 34 can determine the position or direction of movement of puck 14 from the changes in relative capacitance. Puck 14 can also include a suitable sensor (not shown for purposes of clarity) that detects the presence of the user's finger, i.e., detects a downward force along axis 24. The position or direction of movement of puck 14 is transmitted to the host device (e.g., laptop computer, PDA, etc.) in response to detection of such a force. The host device typically uses this information to control the position and movement of a cursor displayed on a screen (not shown).

With puck 14 offset from the center of the circular area in which it is movable (e.g., as shown in FIG. 3), when the user lifts his or her finger, the magnetic force re-centers puck 14 in that area. Also, when the user lifts his or her finger from puck 14, the position or direction of movement of puck 14 is not transmitted to the host device (or, alternatively, the host device is caused to ignore any position or direction information that may be transmitted). Thus, as with conventional pointing devices that re-center themselves, re-centering pointing device 10 does not affect the cursor position.

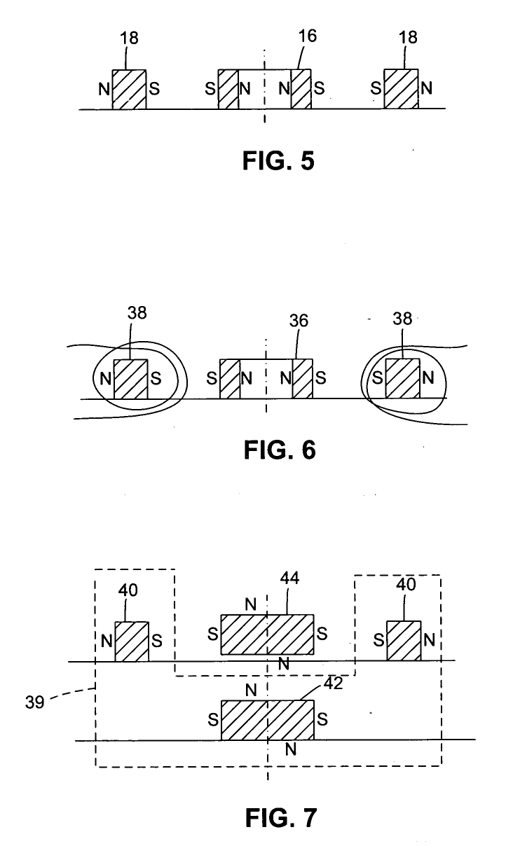

The magnetic interaction that causes the above-described re-centering can readily be understood with further reference to FIG. 5. In the illustrated embodiment of the invention, surfaces of first magnet system 16 and second magnet system 18 that face or oppose each other have the same polarizations, thereby causing them to repel each other. Thus, in this concentric magnet embodiment, the exterior annular surface of first magnet system 16 and the interior annular surface of second magnet system 18 can each have a “South” (“S”) polarization as shown or, alternatively, they can each have a “North” polarization. In other embodiments of the invention, the polarizations will depend upon the shape and arrangement of the magnets.

Note that when puck 14 is centered, as shown in FIG. 1, the repulsive magnetic forces act equally in all of the various lateral directions about puck 14, with forces in opposing directions canceling each other. The resultant of these forces exerted upon puck 14 in all of the various directions is zero, and puck 14 remains centered with respect to base 12. When the user moves puck 14 off center, the resultant force is no longer zero, and a force is exerted upon puck 14 in a direction toward the center. If the user then lifts his or her finger, the force moves puck 14 in that direction until it is re-centered.

As illustrated in FIG. 6, in another embodiment of the invention, one or both of the magnet systems 36 and 38 can comprise an electromagnet (as indicated by the windings depicted in generalized form around an annular core). As noted above, one or both of the magnet systems can have any suitable number, combination and arrangement of permanent magnets, electromagnets and similar magnetic elements.

As illustrated in FIG. 7, in still another embodiment of the invention, the second magnet system 39 comprises not only an annular magnet 40 but also another (in this case, disc-shaped) magnet 42 that at least to some extent levitates or supports the puck to counteract friction between the puck and the base. In other words, the resultant force exerted upon the puck by the magnetic repulsion between the second and first magnet systems 38 and 44, respectively, has components in both lateral and axial directions, with the axial force opposing the weight of the puck. A similar effect could be obtained with a magnet that generates a field having an uncommon shape such that it exerts a force upon the puck having components in both the lateral and axial directions. Counteracting frictional forces in this manner enables the puck to slide more smoothly over the base.

It will be apparent to those skilled in the art that various modifications and variations can be made to this invention without departing from the spirit or scope of the invention. Thus, it is intended that the present invention cover the modifications and variations of this invention provided that they come within the scope of any claims and their equivalents. With regard to the claims, no claim is intended to invoke the sixth paragraph of 35 U.S.C. Section 112 unless it includes the term “means for” followed by a participle.

What is claimed is:

1. An apparatus, comprising:
a base;
a puck movably disposed in an area of the base, the puck movable in a generally planar region within the area of the base in directions lateral to an axis perpendicular to the planar region;
a first magnet system fixedly coupled to the puck;
a second magnet system fixedly coupled to the base, the first and second magnet systems interacting with each other with a resultant lateral magnetic force of zero exerted upon the puck with respect to the base when the puck is centered within the area and with a resultant non-zero centrally-directed lateral magnetic force exerted upon the puck when the puck is not centered within the area, whereby the resultant lateral magnetic forces tend to maintain the puck centered within the area; and
a transducer system responsive to movement of the puck with respect to the base.

2. The apparatus of claim 1, wherein the puck is laterally held within the area of the base solely by the resultant magnetic force.

3. The apparatus of claim 1, wherein the second magnet system comprises a second annular magnet, and the puck is disposed within the second annular magnet.

4. The apparatus of claim 3, wherein the second annular magnet is a permanent magnet.

5. The apparatus of claim 3, wherein the first magnet system comprises a first annular magnet concentrically disposed within the second annular magnet.

6. The apparatus of claim 5, wherein the first annular magnet is a permanent magnet.

7. The apparatus of claim 1, wherein the first and second magnet systems further interact with each other with a resultant non-zero axial magnetic force directed at least in part in an upward axial direction upon the puck and opposing a weight of the puck, whereby the axial magnetic force tends to at least in part support the puck on the base.

8. An apparatus, comprising:
a base;
a puck movably disposed in an area of the base, the puck movable in a generally planar region within the area of the base in directions lateral to an axis perpendicular to the planar region;
means for magnetically opposing a force applied to the puck in a lateral direction away from a centered position within an area of the base in which the puck is disposed and for maintaining the puck in the centered position when the user is not applying force to the puck; and
a transducer system responsive to movement of the puck with respect to the base.

9. The apparatus of claim 8, wherein the puck is laterally held within the area of the base solely by magnetic force provided by the means for magnetically opposing a force.

10. The apparatus of claim 8, wherein the means for magnetically opposing a force comprises at least one annular magnet.

11. The apparatus of claim 10, wherein the annular magnet is a permanent magnet.

12. The apparatus of claim 10, wherein the means for magnetically opposing a force comprises a first annular magnet concentrically disposed within a second annular magnet.

13. The apparatus of claim 12, wherein the first and second annular magnets are permanent magnets.

14. The apparatus of claim 8, wherein the means for magnetically opposing a force further magnetically opposes a weight of the puck to at least in part support the puck on the base.

15. A pointing method for inputting directional information to a host using a pointing device having a puck and a base, comprising the steps of:
a user applying a force to the puck to move the puck laterally away from a centered position within an area of the base in which the puck is disposed;
a first magnet system associated with the puck interacting with a second magnet system associated with the base to oppose the force applied by the user;
producing a directional information signal in response to movement of the puck by the user with respect to the base; and
wherein if the user ceases to apply the force to the puck, the first magnet system interacts with the second magnet system to return the puck to the centered position.

16. The pointing method of claim 15, wherein the first magnet system further magnetically interacts with the second magnet system to oppose a weight of the puck.
